(19) United States
(12) Patent Application Publication
(10) Pub. No.: US 2021/0325183 A1
(43) Pub. Date: Oct. 21, 2021

(54) IMFORMATION PROCESSING DEVICE, SURVEY SYSTEM, AND MULTIFUNCTIONAL SURVEYING APPARATUS

(71) Applicant: TOPCON CORPORATION, Tokyo (JP)

(72) Inventors: Takeshi KIKUCHI, Tokyo (JP); Yuji TAKANO, Tokyo (JP)

(21) Appl. No.: 17/229,309

(22) Filed: Apr. 13, 2021

(30) Foreign Application Priority Data
Apr. 20, 2020 (JP) 2020-075013

(51) Int. Cl. G01C 15/00; G06K 9/00; G06N 20/00; G06Q 50/08

(52) U.S. Cl. CPC G01C 15/002; G06K 9/00624; G01S 19/14; G06Q 50/08; G06N 20/00

(57) ABSTRACT

Provided is an information processing device configured to collect order information related to order details of surveying work, operation-related information related to a surveying operation for performing the surveying work, and a site surrounding image of the surveying work in relation to a plurality of kinds of surveying instruments; to store the order information, the operation-related information, and the site surrounding image; and to execute machine learning by using teacher data including the order information and the site surrounding image, and the operation-related information, and generate a learning model for estimating a surveying work, a surveying instrument, and a surveying method for performing new surveying work according to order information and a site surrounding image related to the new surveying work.

### CROSS-REFERENCE TO RELATED APPLICATION

The present application claims priority under 35 U.S.C. § 119 to Japanese Patent Application No. 2020-075013 filed Apr. 20, 2020. The contents of this application are incorporated herein by reference in their entirely.

### TECHNICAL FIELD

The present invention relates to an information processing device, a survey system, and a multifunctional surveying apparatus.

### BACKGROUND ART

Conventionally, as described in Non-Patent Literature 1, various kinds of surveying instruments have been developed. These surveying instruments have configurations different from each other depending on their functions. As illustrated in FIG. 1, a plurality of kinds of instruments can be used for surveying work for the same purpose in many cases.

Even with instruments of the same kind, different surveying methods such as a backward intersection method, a radiation observation, and a traverse method can be selected to perform surveying operation for the same purpose. There are instruments which are of the same kind but are types with different measuring accuracies.

Therefore, at a work site, work is performed by selecting a surveying instrument and a surveying method to be used in consideration of order details, in particular, the accuracy of the required deliverables and site conditions (for example, whether there are many obstacles at the site, whether there is a known point, etc.).

### CITATION LIST

### Patent Literatures

[Patent Literature 1] Japanese Published Unexamined Patent Application No. 2019-15642
[Patent Literature 2] Japanese Published Unexamined Patent Application No. 2018-48868
[Patent Literature 3] Japanese Published Unexamined Patent Application No. 2015-40831
[Patent Literature 4] Japanese Published Unexamined Patent Application No. 2004-212058
[Patent Literature 5] Japanese Published Unexamined Patent Application No. 2019-178983
[Patent Literature 6] Japanese Published Unexamined Patent Application No. 2019-23653

### Non-Patent Literature

[Non-Patent Literature 1] Topcon i-Construction General Catalog

### SUMMARY OF INVENTION

### Technical Problem

Therefore, a worker must select a surveying method suitable for order details and site conditions based on his/her experience and knowledge, and must become skilled. However, there was a problem in which such experience and knowledge were extensive and difficult to acquire.

The present invention has been made in view of these circumstances, and an object thereof is to provide a technology capable of selecting an optimum surveying method according to order details and site conditions from surveying methods that plural kinds of surveying instruments can execute.

### Solution to Problem

In order to achieve the object described above, an information processing device according to an aspect of the present invention includes: an acquiring unit configured to collect order information related to order details of surveying work, operation-related information related to a surveying operation for performing the surveying work, and a site surrounding image of the surveying work, in relation to a plurality of kinds of surveying instruments; a collected data storage unit configured to store the order information, the operation-related information, and the site surrounding image; and a learning model generating unit configured to execute machine learning by using teacher data including the order information and the site surrounding image as input data, and the operation-related information as output data, and generate a learning model for estimating a surveying work, a surveying instrument, and a surveying method for performing new surveying work according to order information and a site surrounding image related to the new surveying work, wherein the operation-related information includes information on a surveying operation, a surveying instrument, and a surveying method for executing surveying work, and the learning model generating unit executes machine learning by extracting the type of survey of the surveying work, attributes of a surveying object, and required deliverables accuracy as characteristics from the order information.

In the aspect described above, it is also preferable that the information processing device further includes: an estimation request acquiring unit configured to accept order information and a site surrounding image related to the new surveying work together with a request to estimate a surveying work, a surveying instrument, and a surveying method; an estimating unit configured to estimate a surveying operation, a surveying instrument, and a surveying method for performing the new surveying work; a results providing unit configured to provide results of the estimation; a learning model storage unit configured to store the learning model; and a results provision condition storage unit configured to store a provision condition of the estimation results, wherein upon acquisition of the estimation request, the estimating unit estimates a surveying work, a surveying instrument, and a surveying method for executing the new surveying work from order information related to the new surveying work based on the learning model, and the results providing unit provides results of the estimation by applying the provision condition.

A survey system according to another aspect of the present invention includes: the information processing device according to the aspect described above; and a multifunctional surveying apparatus having functions of a plurality of kinds of surveying instruments, and including a control arithmetic unit configured to control the functions of the plurality of kinds of surveying instruments, and a camera, wherein the control arithmetic unit includes an order information accepting unit configured to accept order information of new surveying work, a surrounding image acquiring unit configured to acquire a site surrounding image by the camera, an estimation requesting unit configured to transmit the order information and the site surrounding image to the information processing device together with a request to estimate a surveying work, a surveying instrument, and a surveying method, a results acquiring unit configured to acquire results of the estimation from the information processing device, a results selecting unit configured to select a surveying method to be executed from the estimation results, and an execution enabling unit configured to enable execution of a survey program for causing the multifunctional surveying apparatus to execute the selected surveying method.

In the aspect described above, it is also preferable that the multifunctional surveying apparatus further includes a multifunctional apparatus-side condition accepting unit configured to accept a multifunctional apparatus-side condition surrounding the multifunctional surveying apparatus at the site when providing the estimation results, the operation-related information further includes information corresponding to the multifunctional apparatus-side condition, the estimation requesting unit transmits the multifunctional apparatus-side condition to the information processing device together with the estimation request, and the results providing unit provides the estimation results to the multifunctional surveying apparatus by applying the multifunctional apparatus-side condition to the estimation results.

It is also preferable that the multifunctional apparatus-side condition includes at least one of the conditions for accessories carried to the site, the number of workers sent to the site, and a work required time.

A multifunctional surveying apparatus according to another aspect of the present invention includes a control arithmetic unit having functions of a plurality of kinds of surveying instruments and configured to control the functions of the plurality of kinds of surveying instruments, and a camera, wherein the control arithmetic unit includes an order information accepting unit configured to accept order information of new surveying work, a surrounding image acquiring unit configured to acquire a site surrounding image by the camera, an estimation requesting unit configured to output the order information and the site surrounding image, and request estimation of a surveying work, a surveying instrument, and a surveying method, a results acquiring unit configured to acquire estimation results based on a learning model, a results selecting unit configured to select a surveying method to be executed from the estimation results, and an execution enabling unit configured to enable execution of a survey program for causing the multifunctional surveying apparatus to execute the selected surveying method, the learning model is generated by executing machine learning of order information related to order details of surveying work, operation-related information related to a surveying work for performing the surveying work, and a site surrounding image of the surveying work, collected in relation to the plurality of surveying instruments, by using teacher data including the order information and the site surrounding image as input data, and the operation-related information as output data.

In the aspect described above, the multifunctional surveying apparatus further includes a surveying operation executing unit configured to execute a survey program for causing the multifunctional surveying apparatus to execute a selected work, wherein the estimation results include results related to a plurality of surveying work, and the surveying operation executing unit is configured so that, when the multifunctional surveying apparatus is installed at a predetermined point, in a case where there are a plurality of surveying work to be executed in relation to the point, the surveying operation executing unit can sequentially and individually execute the respective surveying work.

### Effect of Invention

The information processing device, the survey system, and the surveying apparatus according to the aspects described above provide a technology capable of selecting an optimum surveying method according to order details and site conditions from surveying methods that a plurality of surveying instruments can execute.

### BRIEF DESCRIPTION OF DRAWINGS

FIG. 1 is a table illustrating relationships between surveying work and kinds of conventional surveying instruments to be used for the surveying work.

FIG. 2 is a diagram illustrating an outline of a survey system according to an embodiment.

FIG. 3 is a diagram schematically describing a learning data set for learning model generation using the same system.

FIG. 4 is a view illustrating an example of an entire configuration of the same system.

FIG. 5 is a configuration block diagram of an information processing device relating to the same system.

FIG. 6 is an external schematic view of a multifunctional surveying apparatus of the same system.

FIG. 7 is a configuration block diagram of the multifunctional surveying apparatus of the same system.

FIG. 8 is a chart illustrating a correlation between functions included in the multifunctional surveying apparatus described above and components for realizing the functions.

FIG. 9 is a flowchart of processing of the information processing device in a learning mode.

FIG. 10 is a flowchart of processing of the surveying apparatus in an estimation mode.

FIG. 11 is a flowchart of processing of the information processing device in the estimation mode.

FIG. 12 is a view illustrating an example of display of estimation results using the same system.

FIGS. 13A and 13B are respectively views illustrating examples of an order instruction sheet, an order drawing, and a site surrounding image used for estimation in the example in FIG. 12.

FIG. 14 is a flowchart when executing a surveying work of the multifunctional surveying apparatus according to the embodiment described above.

FIG. 15 is a configuration block diagram of an information processing device according to a modification of the embodiment described above.

FIG. 16 is a configuration block diagram of a multifunctional surveying apparatus according to the same modification.

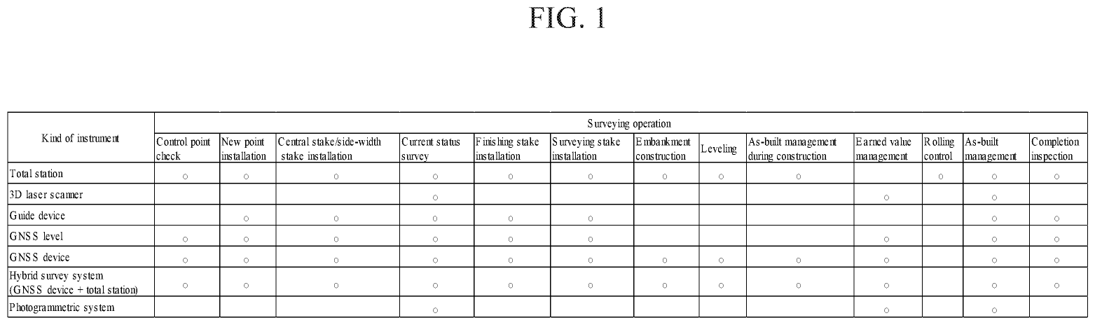

### DESCRIPTION OF EMBODIMENT

Hereinafter, a preferred embodiment and modifications of the present invention will be described with reference to the drawings, however, the present invention is not limited to these. In the embodiment and modifications, the same components are provided with the same reference sign, and overlapping description will be omitted as appropriate.

### 1. Embodiment

### 1.1 Definition

In this description, the kind of a surveying instrument is classified as a total station, a 3D laser scanner, a GNSS level, etc.

In this description, the type of a surveying instrument is classified by performance or function among surveying instruments (for example, total stations) of the same kind, for example, a type with measurement accuracy of 1″ (that is, an instrument whose minimum unit of measurement angle is 1″), a type with accuracy of 5″, etc.

In this description, the type of survey is classified as control point survey, leveling, topographical survey, and applied survey (river surveying, cadastral survey, route survey, sounding, topographical survey, tunnel survey, land development survey, etc.).

In this description, surveying work is one survey case in which a contractor accepts an order from a contractee. A survey case is ordered according to various purposes of survey, and the type of survey is selected according to the purpose of the survey. One, two or more types of survey may be selected.

In this description, operation-related information is information related to an operation for performing certain surveying work, and includes an executed surveying work, the kind and type of surveying instrument used to execute the surveying work, and an executed surveying method.

In this description, the surveying operation is a work necessary for performing a certain type of survey. For example, route survey requires surveying operation such as road surveying, center-line surveying, benchmark installation surveying, profile leveling, cross-sectional surveying, central stake/side-width stake installation, construction of an embankment, as-built management during construction, and as-built management.

In this description, a surveying method in operation-related information is a surveying method that can be used for each surveying operation. Specifically, a surveying method is classified as a traverse method, a radiation observation method, a backward intersection method, photogrammetry, etc. There is a case where two or more surveying methods can be used for one surveying operation. For example, when performing center-line surveying, by using a total station, a backward intersection method can be employed, or a radiation observation method can be employed. In respective surveying instruments, surveying methods of the respective surveying operation is performed by executing respective corresponding programs.

In this description, a site surrounding image is an image of the area around a survey site and acquired as part of the deliverables of a surveying work or as reference information. A site surrounding image is typically acquired by a camera equipped with a surveying instrument installed at a survey site.

Attributes of a surveying object are classified as, for example, a mountainous area, a hilly area, a flatland area, a river, an urban area, a wilderness, a forest, indoors, etc. According to the attributes, required deliverables accuracy and a density of measurement points may differ even for the same type of survey.

### 1.2 Outline of Survey System

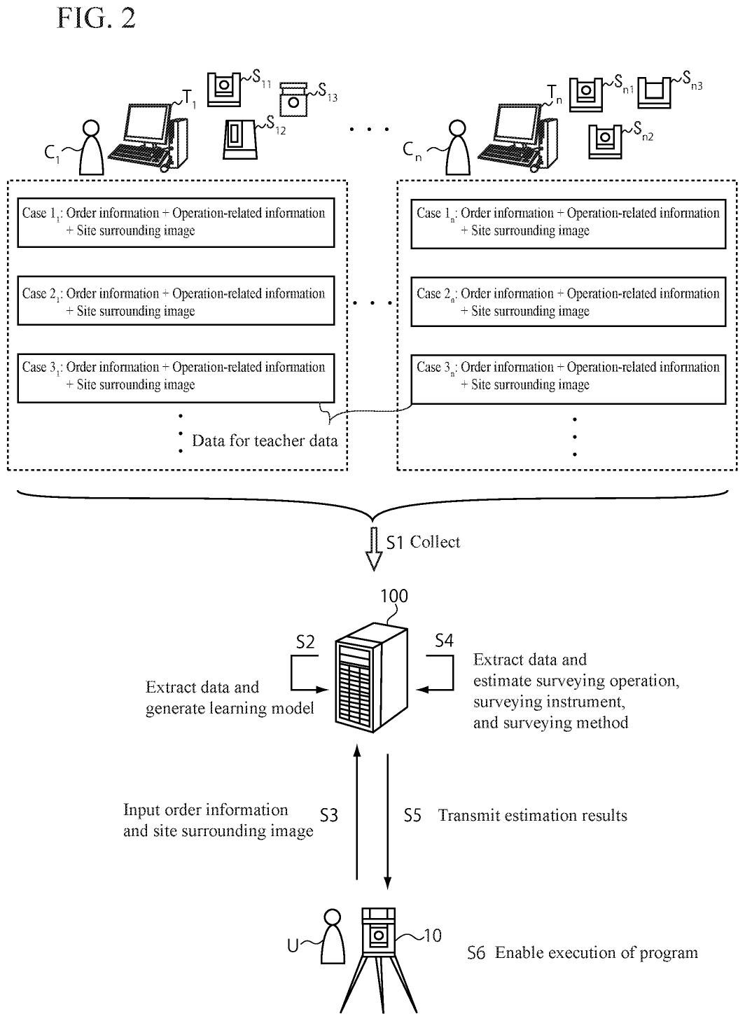

FIG. 2 is a diagram illustrating an outline of a survey system (hereinafter, also simply referred to as a system) 1 according to an embodiment.

An information processing device 100 is, for example, a management server that is owned by a manufacturer or a management company of a surveying instrument. Terminal devices T₁, T₂ . . . , Tₙ (hereinafter, represented as the terminal devices T unless a description is given by focusing on one terminal device) are general-purpose computer terminals such as a notebook PC, a desktop PC, and a tablet terminal that are owned by contractors C₁, C₂ . . . , Cₙ (hereinafter, collectively referred to as the contractors C) accepting orders for surveying work.

The contractors C are a survey department, etc., of a surveying office or civil engineering and construction company, each owning or managing at least one surveying instrument S₁₁ . . . , S₂₁ . . . , Sₙ₁ . . . (hereinafter, collectively referred to as surveying instruments S).

The information processing device 100, the terminal devices T, and the surveying instruments S are connected to be capable of communicating with each other through a communication network N.

The surveying instruments S are, for example, total stations, 3D laser scanners, guide devices, GNSS (Global Navigation Satellite System) levels, GNSS devices, hybrid survey systems, photogrammetric systems, etc.

A total station is a device to acquire position coordinates of a target by measuring a distance and an angle to the target, and has a configuration described in, for example, Patent Literature 1, etc.

A 3D laser scanner is a device to acquire point cloud data of a measurement area by scanning the measurement area by a pulse laser and measuring distances and angles to pulse laser irradiation points. The 3D laser scanner has a configuration described in, for example, Patent Literature 2, etc.

A guide device is a device to guide a worker holding a target to a surveying point by monitoring a position of the target by an automatic tracking function and controlling a guide light irradiation state based on the target position. The guide device has a configuration described in, for example, Patent Literature 3, etc. The guide device uses a 360° prism as an accessory.

A GNSS level is a so-called RTK (Real-Time Kinematic)-GNSS positioning device. The GNSS level has a configuration described in, for example, Patent Literature 4, etc. The GNSS level uses, as an accessory, a light receiving device that receives a laser light emitted from a GNSS level main body and detects a position and an angle of the laser light.

A GNSS device is a device that detects its own position by recognizing a distance from a satellite to an observation point by simultaneously acquiring four or more navigation satellite signals, and has a configuration described in, for example, Patent Literature 5, etc.

A hybrid survey system is a total station using, as an accessory, a GNSS device integrated with a 360° prism disclosed in, for example, Non-Patent Literature 1.

A photogrammetric system has a configuration disclosed in, for example, Patent Literature 6, etc. Specifically, the photogrammetric system is a system that uses, as an accessory, a UAV (Unmanned Aerial Vehicle) unit equipped with a prism and a camera, and performs photogrammetry by taking photos by the UAV while detecting a position of the UAV by a total station with an automatic tracking function.

In addition, the information processing device 100 can communicate with a multifunctional apparatus 10 owned by a user U through the communication network N. The user U may be the contractors C.

### 1.3 Outline of Processing

Hereinafter, an outline of processing of the system 1 will be described. In Step S1, the information processing device 100 collects order information, operation-related information, and site surrounding images via the terminal devices T, related to survey works.

The contractors C upload (transmit) various data related to surveying works to the information processing device 100 for each case from the terminal devices T through a surveying instrument managing webpage provided by a manufacturer, for example. In particular, the contractors C upload order information when accepting an order for surveying work, operation-related information when executing the surveying work and a site surrounding image acquired in the survey work to the information processing device 100. In this way, the information processing device 100 collects order information operation-related information, and site surrounding images as part of records on surveying work to be executed with the surveying instruments owned or managed by the contractors C.

Order information, operation-related information, and site surrounding images are stored in a collected data storage unit 121 of the information processing device 100 in association with a case ID. In this way, the order information, operation-related information, and the site surrounding images (hereinafter, referred to as collected data when these are collectively referred to) are collected by the information processing device 100.

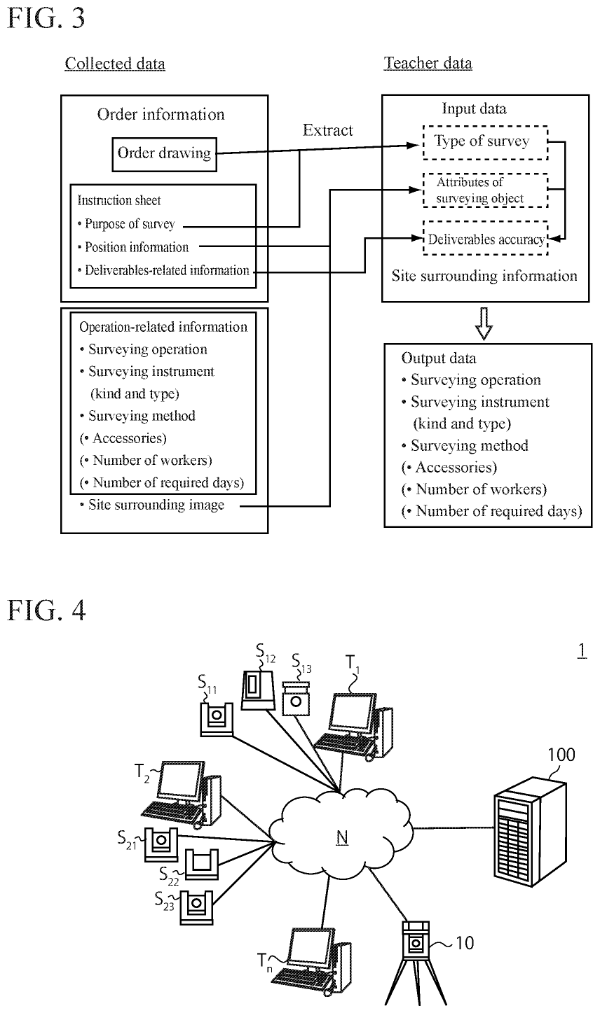

FIG. 3 illustrates an outline of the collected data and an outline of teacher data to be used for generation of a learning model.

The order information is information described in an order drawing and an instruction sheet that are submitted from a contractee to the contractors C when the contractors C accept an order for surveying work.

The order drawing is a schematic view of a region to be surveyed. The region to be surveyed has a characteristic shape according to the type of survey. Conventionally, a worker grasps the type of survey from the purpose of the survey described in the order drawing and instruction sheet.

The instruction sheet contains at least the purpose of the survey, position information of a surveying object, and deliverables-related information.

The purpose of the survey is information related to the purpose of the ordered survey. For example, the purpose is described by using various expressions such as, “Control point survey for urban design,” “For *** road construction,” and “Survey for land sales,” etc., and the type of survey may be clearly designated or not designated. Usually, a worker grasps the type of survey to be performed from described details including features of the order drawing and the purpose of the survey, etc.

Position information of a surveying object is described in the instruction sheet in the form of, for example, position coordinates, address, or regional indication (the east of *** City, etc.), etc., of the surveying object.

The deliverables-related information is information related to accuracy required for deliverables (hereinafter, referred to as deliverables accuracy) described in an instruction sheet by using as expressions, for example, “According to the regulations of ***,” “Scale: 1/25000,” and “Point cloud density: High/Medium/Low,” etc. Usually, a worker grasps required deliverables accuracy from the “order drawing,” the “position information,” and the “deliverables-related information” by referring to the regulations of the Geospatial Information Authority of Japan, etc. For example, leveling in periodic profile leveling of a mountainous area in a river survey requires accuracy regulated as 4th class leveling, and periodic profile leveling of a flatland area in a river survey requires accuracy regulated as 3rd class leveling.

The operation-related information and the site surrounding images are as defined above.

Next, in Step S2, the information processing device 100 executes machine learning by using the order information, the operation-related information, and the site surrounding image as teacher data.

Next, in Step S3, from a multifunctional apparatus 10 installed at the site, the user U transmits the order information and the site surrounding image, and transmits a request to estimate a surveying operation required according to order details and a surveying instrument and a surveying method (hereinafter, referred to as a surveying method, etc.) for performing the surveying operation.

Next, in Step S4, the information processing device 100 estimates a surveying method, etc., for performing the surveying work suitable for order details based on a learning model generated in Step S2.

Next, in Step S5, the information processing device 100 transmits the estimation results to the multifunctional apparatus 10. Next, in Step S6, the multifunctional apparatus 10 is enabled to execute a program for executing the estimated surveying method by using functions of the estimated surveying instrument.

### 2. Configuration of Survey System

### 2.1 Entire Configuration

Details of the system 1 will be described. As illustrated in FIG. 4, the system 1 includes the information processing device 100 and the multifunctional apparatus 10. The information processing device 100 and the multifunctional apparatus 10 are connected to each other to be capable of communicating wirelessly or by wire through the communication network N. The information processing device 100 is configured to be capable of communicating with the terminal devices T for contractors C managing his/hers surveying instrument S owned by the contractors C though the communication network N.

The communication network N is, for example, a LAN (Local Area Network) or WAN (Wide Area Network) such as the internet. Information to be transmitted and received among the information processing device 100, the multifunctional apparatus 10, and the terminal devices T is managed in association with a case number of surveying work. Each case of surveying work is managed in association with an ID of a user U and the contractor C.

### 2.2 Information Processing Device 100

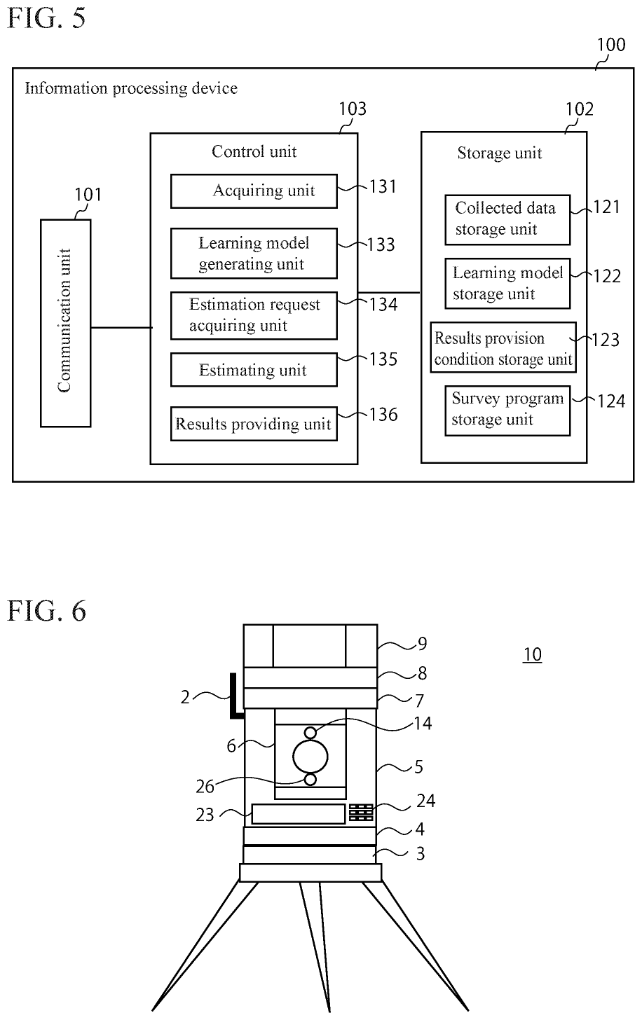

The information processing device 100 is a computer for a server. As illustrated in FIG. 5, the information processing device 100 includes a communication unit 101, a storage unit 102, and a control unit 103.

The communication unit 10 is a communication control device such as a network adapter, a network interface card, a LAN card, etc., and connects the information processing device 100 to the communication network N by wire or wirelessly. The control unit 103 can transmit and receive various information to and from the multifunctional apparatus 10 and the terminal devices T through the communication unit 101 and the communication network N.

The storage unit 102 is a computer-readable recording medium that stores and transmits information in a computer-processable form. As the storage unit 102, for example, a semiconductor memory device such as a RAM (Random Access Memory) and a flash memory, or an electronic medium such as an HDD (Hard Disc Drive) and an optical disc can be adopted.

The storage unit 102 stores a program for causing the information processing device 100 to execute processing for generating a learning model according to the present embodiment, and processing for selecting a surveying instrument and a surveying method. The storage unit 102 includes a collected data storage unit 121, a learning model storage unit 122, a results provision condition storage unit 123, and a survey program storage unit 124.

The collected data storage unit 121 stores collected data collected from the terminal devices T. The learning model storage unit 122 stores a learning model generated by the learning model generating unit 133. The results provision condition storage unit 123 stores a condition for providing selection results of the estimating unit 135 to the multifunctional apparatus 10. This condition includes, for example, excluding results that do not include the functions included in the multifunctional apparatus 10, giving priority to results with a smaller number of required days, giving priority to results with a smaller number of workers, etc.

The survey program storage unit 124 stores an execution program for performing an estimated surveying work by an estimated surveying method by using functions corresponding to the estimated surveying instrument S.

The control unit 103 includes, for example, a microcomputer including a CPU (Central Processing Unit), a ROM (Read Only Memory), a RAM, an input/output port, etc., and various circuits. The control unit 103 includes an acquiring unit 131, a learning model generating unit 133, an estimation request acquiring unit 134, an estimating unit 135, and a results providing unit 136.

The respective functions of the control unit 103 may be realized by hardware such as FPGA (Field Programmable Gate Array), or may be realized by executing a program in the storage unit 102 by the CPU.

The acquiring unit 131 acquires collected data through the communication unit 101. The collected data is uploaded from the terminal devices T through the webpage. Part of the collected data, for example, operation-related information and site surrounding images may be collected by the surveying instrument S at the end of a surveying work relating to the case in association with a case ID by user's work or by automatically uploading at each completion of surveying work through the communication network N. The acquiring unit 131 stores the collected data acquired from the terminal devices T in the collected data storage unit 121.

The learning model generating unit 133 extracts at least “Type of survey,” “Attributes of surveying object,” “Deliverables accuracy,” and site surrounding information from collected data acquired from the terminal devices T or the multifunctional apparatus 10, and generates a learning model by executing machine learning by using teacher data set including the extracted data as input data and the operation-related information as output data. The learning model estimates, when order information and a site surrounding image for a new surveying work are input, a surveying operation, a surveying instrument, and a surveying method for carrying out the new surveying work. The learning model is realized, for example, by a neural network that uses one or more layers of nonlinear units to predict the output for the input. In particular, the machine learning can be performed by any method such as logistic regression, SVM (Support Vector Machine), Random Forest, CNN (Convolutional Neural Network), RNN (Recurrent Neural Network), or XGBoost (eXtreme Gradient Boosting), etc.

The learning model generating unit 133 extracts “Type of survey” from expressions included in the purpose of the survey described in the instruction sheet and the order drawing. The purpose of the survey is described by using various expressions such as “Control point survey for urban design,” “For *** road construction,” and “Survey for land sales.” Part of the learning model generating unit 133 estimates and extracts the corresponding type of survey from details understood by using AI (Artificial Intelligence) with a publicly known language recognition engine from the expressions included in the purpose of the survey and features of the entire drawing recognized from image data of the order drawing. This processing may be realized based on the details understood from the expressions including the purpose of the survey and a learning model generated by machine learning of a learning data set including the order drawing as input data and the type of survey as output data.

The learning model generating unit 133 extracts attributes of the surveying object by analyzing position information of the surveying object by referring to a topographic map and a map provided by the Geospatial Information Authority of Japan, etc., and a landscape in the site surrounding image by using an image recognition engine.

Further, the learning model generating unit 133 extracts deliverables accuracy from the deliverables-related information, and the type of survey and attributes of the surveying object extracted as described above by referring to the regulations of the Geospatial Information Authority of Japan, etc., described in the deliverables-related information. The regulations of the Geospatial Information Authority of Japan, etc., may be stored in the storage unit 102, or may be acquired through the communication network N. When predetermined accuracy is described in the deliverables-related information, the described accuracy is extracted as deliverables accuracy.

The learning model generating unit 133 extracts site surrounding information from the site surrounding image. The site surrounding information includes information on a state of an object to be measured on a certain measurement date, and obstacles at the site, such as trees and temporary structures, and information on the complexity of the shape of the measuring object, etc.

The estimation request acquiring unit 134 accepts new order information and a site surrounding image from the multifunctional apparatus 10 together with a request to estimate a surveying method, etc.

The estimating unit 135 estimates a surveying method, etc., from order information on the new surveying work accepted by the estimation request acquiring unit 134 based on the learning model stored in the learning model storage unit 122.

The results providing unit 136 provides the estimation results to the multifunctional apparatus 10 by applying a condition stored in the results provision condition storage unit 123.

The terminal device T for collecting data includes at least a communication unit connectable to the communication network N, a document scanner that scans a document and converts it into computer-readable electronic data, and browser software capable of displaying webpages. The terminal devices T are general-purpose computer terminals such as personal computers, tablet terminals, etc., so that detailed description of them is omitted.

In the terminal devices T, the order drawing is input as computer-readable image data such as data of PDF (Portable Document Format) or DXF (Drawing Exchange Format).

### 2.3 Multifunctional Surveying Apparatus 10

The multifunctional surveying apparatus (herein after also referred to as “multifunctional apparatus”) 10 is a surveying apparatus including functions of a plural kinds of surveying instrument, for example, a total station; a 3D laser scanner; a guide device; a GNSS level; a GNSS device; a hybrid survey system; and a photogrammetric system.

As illustrated in FIG. 6, the multifunctional apparatus 10 includes, in appearance, in order from the lower side, a base portion 4, a bracket portion 5 that rotates horizontally with respect to the base portion 4, a telescope 6 that rotates vertically in a recessed portion of the bracket portion 5, a rotary laser housing 7 that houses a rotary laser light transmitting unit 15, a GNSS housing 8 that houses a GNSS receiver 16, and a scanner housing 9 that houses a scanner unit 13, and is installed on a leveling base 3 via a tripod. To a side portion of the bracket portion, a radio antenna 2 for wireless communication is attached.

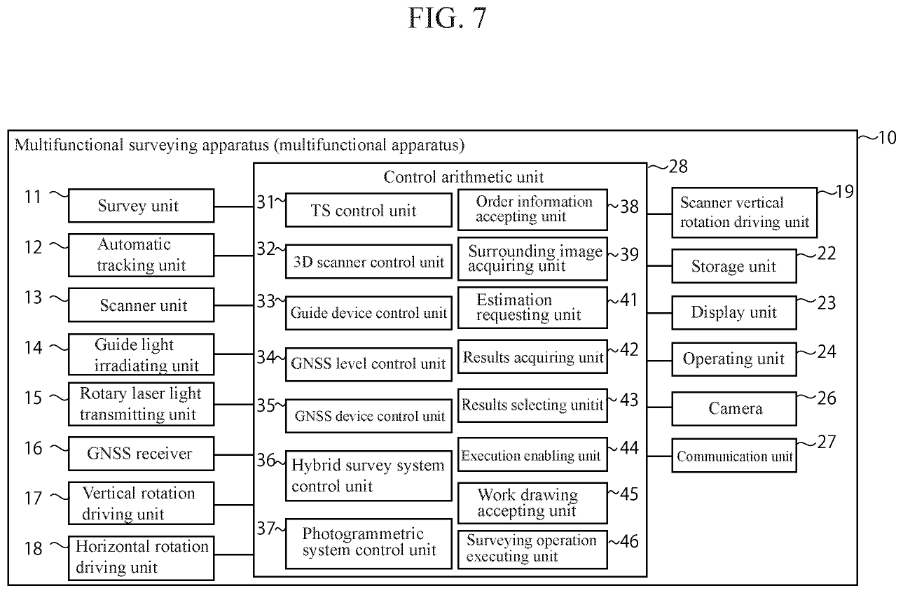

As illustrated in FIG. 7, the multifunctional apparatus 10 includes a survey unit 11, an automatic tracking unit 12, a scanner unit 13, a guide light irradiating unit 14, a rotary laser light transmitting unit 15, a GNSS receiver 16, a vertical rotation driving unit 17, a horizontal rotation driving unit 18, a scanner vertical rotation driving unit 19, a storage unit 22, a display unit 23, a work unit 24, a camera 26, a communication unit 27, and a control arithmetic unit 28.

The survey unit 11 includes a light emitting element, a distance-measuring optical system, and a light receiving element disposed inside the telescope 6. The survey unit 11 measures a distance to a target by emitting distance-measuring light from the light emitting element through the distance-measuring optical system and receiving reflected light from the target by the light receiving element. In addition, the survey unit 11 measures a vertical rotation angle of the telescope 6 and a horizontal rotation angle of (the bracket portion supporting) the telescope 6 by a rotary encoder. The survey unit 11 may have a publicly known automatic collimation function.

The automatic tracking unit 12 includes a light emitting element, a tracking optical system, and a light receiving element disposed inside the telescope 6. When a target moves, the automatic tracking unit 12 automatically tracks the target by emitting tracking light through the tracking optical system and capturing a position of the target based on reflected light from the target.

The scanner unit 13 includes a scanner light emitting element, a scanner optical system, a turning mirror, and a scanner light receiving element. The turning mirror is driven to rotate vertically by the scanner vertical rotation driving unit 19. The scanner unit 13 emits pulse light as scanning light from the scanner light emitting element through the scanner optical system and the turning mirror, and receives reflected light reflected from a measuring object by the scanner light receiving element to measure a distance to an irradiation point.

In addition, a vertical rotation angle of the turning mirror and a horizontal rotation angle of the bracket portion 5 are measured by the rotary encoder to measure an angle of each irradiation point. By cooperation of the scanner vertical rotation driving unit 19 and the horizontal rotation driving unit 18, scanning light is caused to scan all around to acquire 3D point cloud data.

The guide light irradiating unit 14 includes a light emitting element and an optical system, and is configured to irradiate lights in two different colors (for example, red and green visible lights) between the left and the right of a collimation axis of the distance-measuring light.

The rotary laser light transmitting unit 15 includes a turning unit and a laser light source disposed inside the rotary laser housing 7, and is configured to form a horizontal laser reference plane by rotationally irradiating a laser light beam in the horizontal direction.

The GNSS receiver 16 is a built-in antenna navigation signal receiver. The GNSS receiver 16 can acquire an installation point by performing positioning by receiving navigation signals transmitted from four or more GNSS satellites and measuring navigation signal transmission times.

The vertical rotation driving unit 17 is a motor, and drives and rotates the telescope 6 in the vertical direction. The horizontal rotation driving unit 18 is a motor, and drives and rotates the bracket portion 5 in the horizontal direction with respect to the base portion 4.

The scanner vertical rotation driving unit 19 is a motor, and drives and vertically rotates the turning mirror of the scanner unit 13.

The storage unit 22 is a recording medium that stores and transmits information in a computer-processable format. As the storage unit 22, for example, a semiconductor memory device such as a RAM or a flash memory, or an electronic medium such as an HDD or an optical disc, can be employed. The storage unit 22 stores a program for executing processing to be executed by the multifunctional instrument 10.

The display unit 23 is, for example, an organic EL display or a liquid crystal display. The display unit 23 displays a display for inputting order information and an order drawing based on control of the control unit 30. In addition, the display unit 23 displays estimation results received from the information processing device 100.

The work unit 24 includes character keys, numeric keys, an enter key, and a power button, etc. A user U can input order information and various information through the work unit 24. The display unit 23 and the work unit 24 may be integrated as a touch-panel display. In the example in FIG. 6, the display unit 23 and the work unit 24 are disposed on a front surface of the bracket portion.

The camera 26 is a so-called digital camera, and includes an image sensor such as a CCD or a CMOS (Complementary MOS) as an imaging device. The camera 26 is provided so that a collimation axis roughly matches the collimation axis of the telescope, and can acquire a site surrounding image.

The communication unit 27 is a communication control device such as a network adapter, a network interface card, or a LAN card. The communication unit 27 connects the multifunctional apparatus 10 to the communication network N by wire or wirelessly. The control arithmetic unit 28 can transmit and receive various information to and from the information processing device 100 through the communication unit 27 and the communication network N.

The control arithmetic unit 28 includes, for example, a microcomputer including a CPU, a ROM, a RAM, and an I/O port, etc., and various circuits. The control arithmetic unit 28 reads and executes various programs stored in the storage unit 22 and the RAM.

The control arithmetic unit 28 includes a TS control unit 31, a 3D scanner control unit 32, a guide device control unit 33, a GNSS level control unit 34, a GNSS device control unit 35, a hybrid survey system control unit 36, a photogrammetric system control unit 37, an order information accepting unit 38, a surrounding image acquiring unit 39, an estimation requesting unit 41, a results acquiring unit 42, a results selecting unit 43, an execution enabling unit 44, a work drawing accepting unit 45, and a surveying operation executing unit 46. Functions of the control arithmetic unit 28 may be realized by hardware such as FPGA, or may be realized by reading and executing a program from the storage unit 102 or the RAM by the CPU. The units from the TS control unit 31 to the photogrammetric system control unit 37 are realized by reading and executing a survey program for realizing the respective functions.

The TS control unit 31 causes the multifunctional apparatus 10 to execute functions equivalent to a total station with an automatic tracking function by controlling the survey unit 11, the automatic tracking unit 12, the vertical rotation driving unit 17, and the horizontal rotation driving unit 18.

The 3D scanner control unit 32 causes the multifunctional apparatus 10 to execute functions equivalent to a 3D scanner by controlling the scanner unit 13, the horizontal rotation driving unit 18, and the scanner vertical rotation driving unit 19.

The guide device control unit 33 causes the multifunctional apparatus 10 to execute functions equivalent to the guide device of the surveying instrument S by controlling the survey unit 11, the automatic tracking unit 12, and the guide light irradiating unit 14.

The GNSS level control unit 34 causes the multifunctional apparatus 10 to execute functions equivalent to the GNSS level of the surveying instrument S by controlling the rotary laser light transmitting unit 15 and the GNSS receiver 16 and using a light receiving device with another GNSS receiver as accessories.

The GNSS device control unit 35 acquires position coordinates of the multifunctional apparatus 10 as with the GNSS device of the surveying instrument S based on navigation signals received by the GNSS receiver 16.

The hybrid survey system control unit 36 causes the multifunctional apparatus 10 to execute functions equivalent to the hybrid survey system of the surveying instrument S by controlling the survey unit 11, the automatic tracking unit 12, the vertical rotation driving unit 17, and the horizontal rotation driving unit 18 when using a GNSS device with another GNSS receiver as accessories.

The photogrammetric system control unit 37 causes the multifunctional apparatus 10 to execute the same functions as the functions of the photogrammetric system of the surveying instrument S by controlling the survey unit 11, the automatic tracking unit 12, the vertical rotation driving unit 17, and the horizontal rotation driving unit 18 when using a UAV unit with a prism and a camera as accessories.

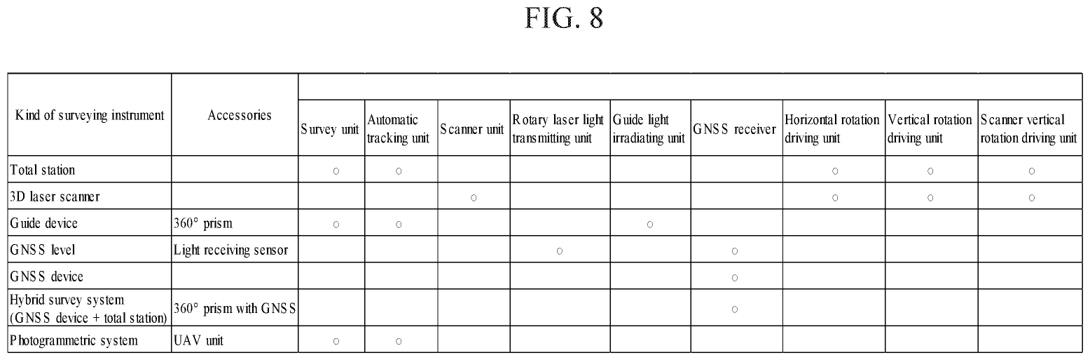

For the sake of understanding, correspondence between the corresponding surveying instruments S and the configurations and accessories of the multifunctional apparatus 10 is illustrated in FIG. 8.

The order information accepting unit 38 accepts the purpose of the survey, position information, and deliverables-related information described in the instruction sheet, and image data of an order drawing. The purpose of the survey, position information, and deliverables-related information are input, for example, by a user from the work unit. The order drawing may be read by a document scanner (not illustrated) and accepted as electronic data in the format of PDF, etc. Alternatively, electronic data of the order drawing may be read and accepted through an external interface such as a USB. Alternatively, the purpose of the survey, position information, and deliverables-related information may be accepted by being recognized by AI-OCR (Optical Character Reader) (not illustrated) by reading the order instruction sheet by the document scanner.

The surrounding image acquiring unit 39 acquires a surrounding image by controlling the camera 26, and converts the acquired image into image data. The site surrounding image may be a panoramic photo taken by 360-degree photography in the horizontal direction by driving the horizontal rotation driving unit 18.

The estimation requesting unit 41 transmits the order information and the site surrounding image to the information processing device 100 together with a request to select a surveying method, etc.

The results acquiring unit 42 receives results of selection of a surveying method, etc., from the information processing device 100 and displays the selection results on the display unit 23. When there is a plurality of required surveying work, it is preferable that all the surveying work is displayed.

The results selecting unit 43 selects a surveying method, etc., to be executed from the displayed estimation results. Specifically, a worker inputs a surveying method, etc., to be selected from the estimation results displayed on the display unit 23 by using the work unit 24. The results selecting unit 43 selects the input surveying method, etc. When there is a plurality of surveying work to be output, the results selecting unit 43 can select one surveying method to be executed for each surveying work.

The execution enabling unit 44 enables the multifunctional apparatus 10 to execute the selected surveying work by the selected surveying method by using functions corresponding to the selected surveying instrument. Specifically, from the survey program storage unit 124 of the information processing device 100, a survey program for executing the selected surveying work by the selected surveying method by using functions corresponding to the selected surveying instrument is downloaded and installed in the multifunctional apparatus 10, and is enabled to be executed by the multifunctional apparatus 10.

The work drawing accepting unit 45 accepts a work drawing. The work drawing is a drawing for a surveying work, created by using CAD data. The work drawing may be accepted by being read in the form of electronic data having coordinate information through an external interface such as a USB.

The surveying operation executing unit 46 executes a survey program by applying the work drawing to the survey program for executing the selected surveying method by using the functions of the selected surveying instrument, and executes the selected surveying method.

### 3. Information Processing Related to Surveying Method Selection

Next, details of processing related to estimation of a surveying method, etc., of the system 1 will be described. This processing has a learning mode in which a learning model is generated by machine learning, and an estimation mode in which a surveying method is estimated based on the learning model.

### 3.1 Learning Mode

### 3.1.1 Processing of Information Processing Device 100

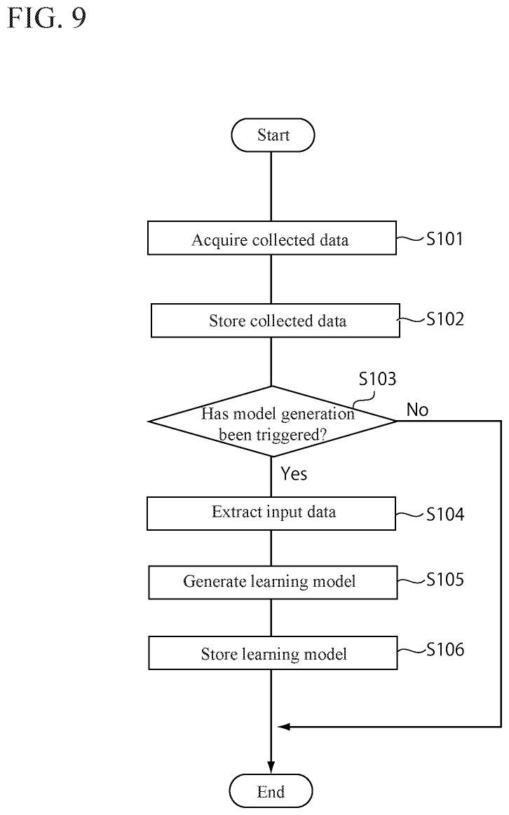

FIG. 9 is a flowchart of processing of the information processing device 100 in the learning mode. The learning mode is started when the contractor C opens a webpage and transmits collected information to the information processing device 100 from a collected data input screen. This processing is repeatedly executed each time the information processing device 100 receives collected data from the terminal device T.

When processing starts, in Step S101, the acquiring unit 131 acquires collected data in association with a case ID from the terminal device T. The collected data does not need to be collected at the same time for all of order information, operation-related information, and a site surrounding image, they may be collected separately.

Next, in Step S102, the acquiring unit 131 stores the collected data in the collected data storage unit 121.

Next, in Step S103, the control unit 103 determines whether generation of a learning model has been triggered. The control unit 103 can generate a trigger for the generation each time a predetermined number of sets of order information, operation-related information, and a site surrounding image for each case are stored in the collected data storage unit 121 or each time a predetermined period of time elapses.

When the generation is not triggered (No), the processing is ended. When the generation is triggered (Yes), the processing shifts to Step S104.

In Step S104, the learning model generating unit 133 extracts the type of survey, attributes of a surveying object, and deliverables accuracy from the order drawing, the instruction sheet, and the site surrounding image. In addition, the learning model generating unit 133 extracts site surrounding information from the site surrounding image.

Next, in Step S105, the learning model generating unit 133 generates or updates a learning model by executing machine learning using the type of survey, the attributes of the surveying object, the deliverables accuracy, and the site surrounding information as characteristics by using teacher data including the type of survey, the attributes of the surveying object, the deliverables accuracy, and the site surrounding image as input data, and an executed surveying operation, a surveying instrument (kind and type) used for executing the surveying operation, and an executed surveying method as output data. Then, in Step S106, the learning model storage unit 122 stores the learning model, and ends the processing.

### 3.2 Estimation Mode

### 3.2.1 Processing of Multifunctional Apparatus 10

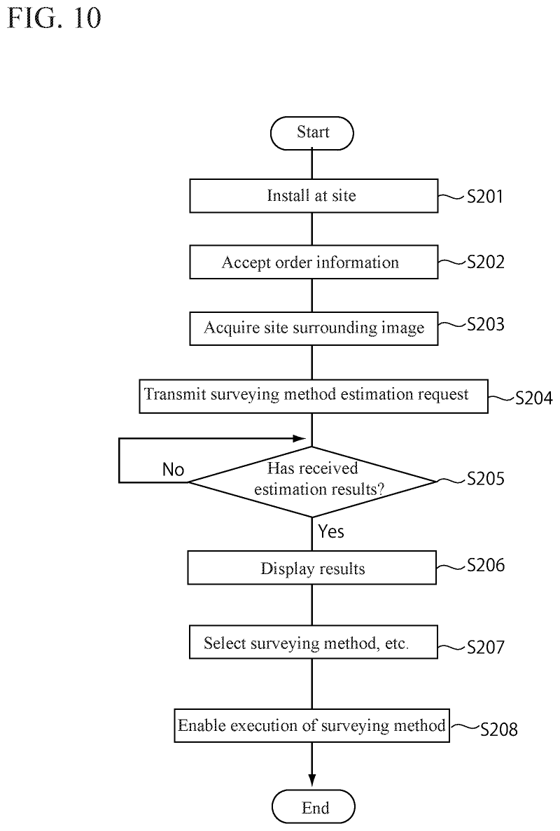

FIG. 10 is a flowchart of processing of the multifunctional apparatus 10 in the estimation mode. When the processing starts, in Step S201, a worker installs the multifunctional apparatus 10 at a location overlooking the survey site, or at a control point.

Next, in Step S202, the order information accepting unit 38 accepts a purpose of the survey, position information, deliverables-related information, and an order drawing as order information.

Next, in Step S203, the surrounding image acquiring unit 39 acquires a site surrounding image by controlling the camera 26. The acquired site surrounding image is output to the order information accepting unit 38.

Next, in Step S204, the estimation requesting unit 41 transmits the order information accepted by the order information accepting unit 38, the site surrounding image acquired by the surrounding image acquiring unit 39, and a request to estimate a surveying method, etc., to the information processing device 100.

Next, in Step S205, the results acquiring unit 42 waits while determining whether estimation results have been received from the information processing device 100. Then, upon reception of estimation results (Yes), in Step S206, the estimation results are displayed on the display unit 23.

Next, in Step S207, the results selecting unit 43 selects a surveying method, etc., selected by the worker from the estimation results displayed on the display unit 23.

Next, in Step S208, the execution enabling unit 44 enables the multifunctional apparatus 10 to execute a program for performing the selected surveying work by the selected surveying method by using functions corresponding to the selected surveying instrument, and ends the processing.

### 3.2.2 Processing of Information Processing Device 100

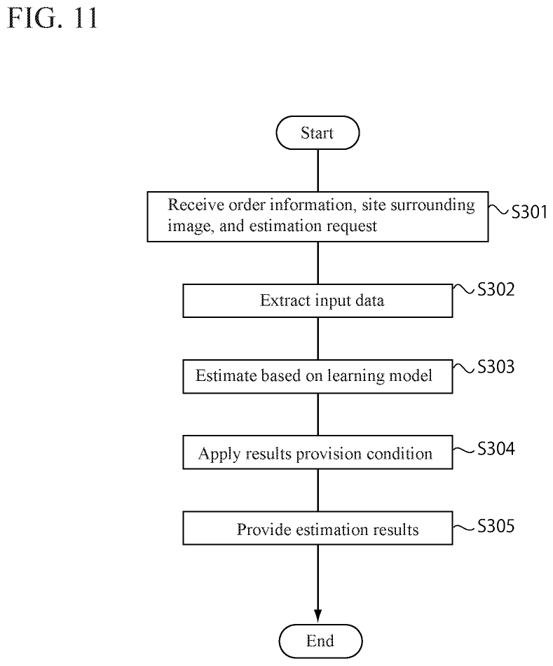

FIG. 11 is a flowchart of processing of the information processing device 100 in the estimation mode. In Step S301, processing starts when the estimation request acquiring unit 134 receives order information, a site surrounding image, and an estimation request from the multifunctional apparatus 10.

Next, in Step S302, the estimating unit 135 extracts the type of survey, attributes of a surveying object, and deliverables accuracy from the order information and the site surrounding image as with the learning model generating unit 133 in Step S104.

Next, in Step S303, the estimating unit 135 estimates a surveying method, etc., according to order details based on a learning model stored in the learning model storage unit 122 by using the type of survey, the attributes of the surveying object, the deliverables accuracy, and the site surrounding image as input data.

Next, in Step S304, the results providing unit 136 applies a results provision condition stored in the results provision condition storage unit 123.

Next, in Step S305, the results providing unit 136 transmits the estimation results to which the results provision condition has been applied to the multifunctional apparatus 10, and ends the processing.

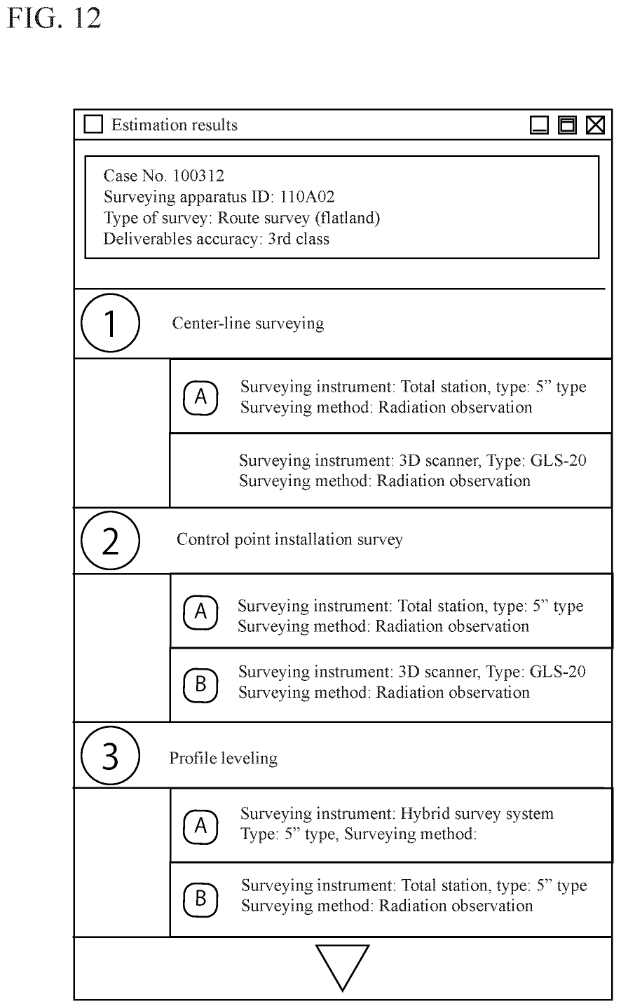

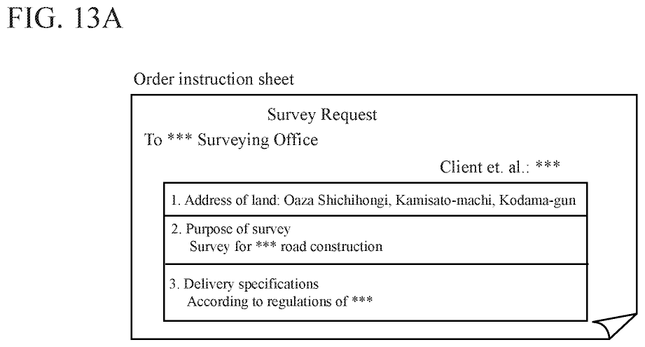

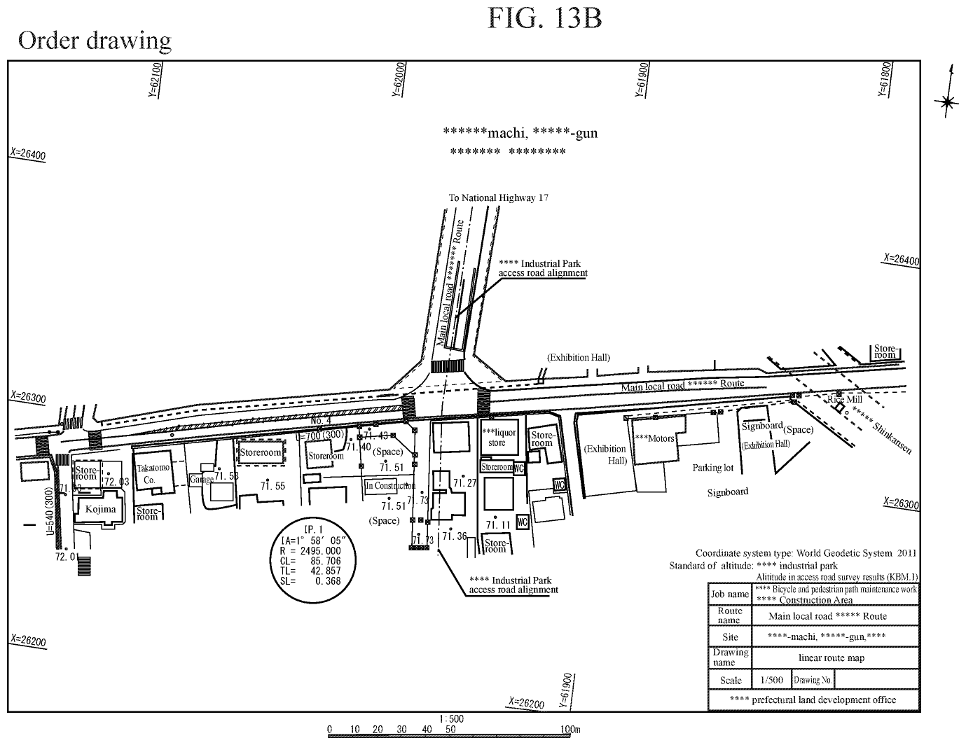

FIG. 12 illustrates an example of display of estimation results displayed on the display unit 23 when the order information accepting unit 38 acquires the order instruction sheet illustrated in FIG. 13A, the order drawing illustrated in FIG. 13B, and a site surrounding image (not illustrated). In FIG. 12, route survey is extracted as the type of survey, a flatland is extracted as a surveying object, and 3rd class accuracy is extracted as deliverables accuracy, and as results of estimation of a surveying method, etc., the kinds and types of surveying instruments and surveying methods for the respective surveying work including center-line surveying, benchmark survey, profile leveling . . . are displayed in descending order of use frequency. A worker can select a surveying method to be executed from the displayed surveying methods to enable the multifunctional apparatus 10 to execute the method.

In this way, according to the present embodiment, the information processing device 100 defines the type of survey, attributes of a surveying object, deliverables accuracy extracted from the order information described in the instruction sheet and a site surrounding image, and the site surrounding image as input data, and a surveying work performed in actuality under the condition described above, and the kind and type of a surveying instrument and a surveying method used for performing the surveying work as output data, and executes machine learning by using these as a teacher data set to generate a learning model. According to this learning model, a surveying work, a surveying instrument (kind and type), and a surveying method suitable for order details and site conditions can be estimated.

Usually, a work chief, etc., thoroughly checks an order instruction sheet and an order drawing, grasps the type of survey to be performed, a required surveying work, attributes of a surveying object, and required deliverables accuracy, and determines the kind and type of a surveying instrument and a surveying method necessary for performing surveying work according to order details. However, at an actual survey site, there are many unexpected obstacles such as electric wires and trees and unexpected points that should be measured, and a planned surveying method may not be optimum. In the present embodiment, input data includes a site surrounding image, so that a surveying instrument and a surveying method according to site conditions can be estimated.

In the present embodiment, the multifunctional apparatus 10 has functions corresponding to the seven surveying instruments listed in FIG. 8. However, the multifunctional apparatus 10 does not necessarily have to have all these functions, but may have functions of two or more surveying instruments. The surveying instruments listed in FIG. 8 are just examples, and the multifunctional apparatus may have functions of other surveying instruments.

A learning model is not limited to the one used only in the information processing device 100 that generates a learning model, but may also be used for estimation of a surveying instrument according to order information by using a learning model generated in the information processing device 100 in other information processing devices, terminal devices, or surveying instruments.

In the present embodiment, a configuration is made in which, for generation of a learning model, order information and operation-related information related to many and various surveying instruments managed by a plurality of terminal devices configured to be capable of communicating with the information processing device 100 can be used as collected data, so that when a work chief is not so skilled or is at a loss to make a determination, estimation results can be used as an indication of determination, so that a more appropriate surveying method, etc., can be selected.

Further, in the present embodiment, in learning model generation, teacher data is continuously collected from many terminal devices connected to the information processing device 100 through the communication network N, and each time predetermined model generation is triggered, a learning model is generated (updated), so that estimation accuracy can be always improved.

### 3.3 Processing of Multifunctional Apparatus 10 When Executing Surveying Operation

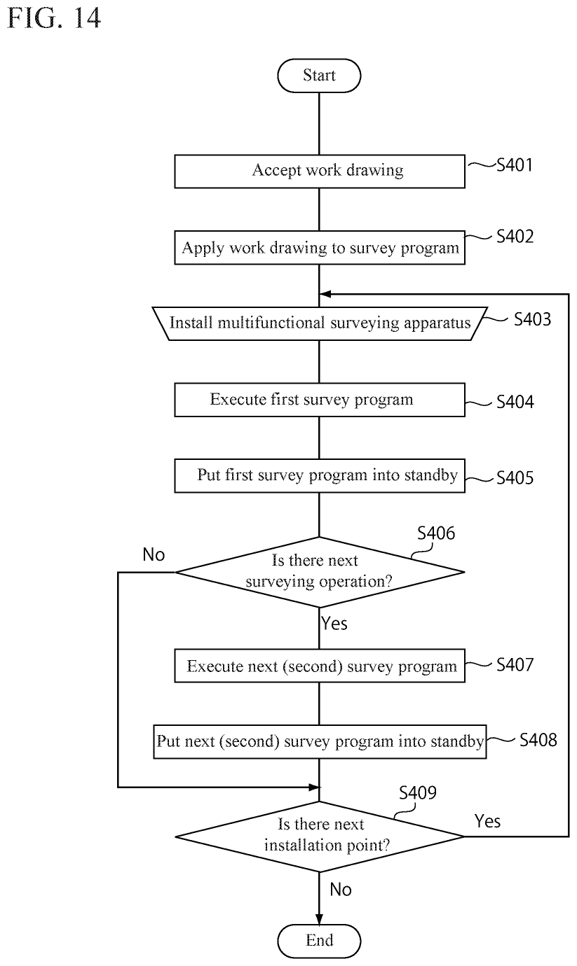

FIG. 14 is a flowchart of processing of the multifunctional apparatus 10 when performing a surveying operation. When starting processing, first, in Step S401, the work drawing accepting unit 45 accepts a work drawing.

Next, in Step S402, the surveying operation executing unit 46 applies the work drawing to a survey program for executing a selected surveying method. When there is a plurality of selected surveying operation, the work drawing is applied to all survey programs.

Next, in Step S403, a worker installs the multifunctional apparatus 10 at a predetermined point. The predetermined point is a point set as a point at which a surveying apparatus (multifunctional apparatus 10) is installed in the work drawing.

Next, in Step S404, the surveying operation executing unit 46 executes a first surveying operation at the installation point by executing a first survey program out of all selected survey programs.

After completion of the first surveying operation at the installation point, in Step S405, the surveying operation executing unit 46 puts execution of the first survey program into standby.

Next, in Step S406, the surveying operation executing unit 46 determines whether there is a surveying operation to be executed next at the current installation point.

When there is a next surveying operation (Yes), in Step S407, the surveying operation executing unit 46 executes the next (second) surveying program and executes a second surveying work at the installation point. After completion of the second surveying operation, in Step S408, the surveying operation executing unit 46 puts execution of the second survey program into standby, and the processing shifts to Step S409.

On the other hand, when there is no next surveying operation (No), the processing directly shifts to Step S409.

Then, in Step S409, the surveying operation executing unit 46 determines whether there is a next installation point. When there is a next installation point (Yes), the processing returns to Step S403, and the multifunctional apparatus 10 is moved to the next installation point, and Steps S403 to S409 are repeated. When there is no next installation point (No), processing is all ended.

Conventionally, in a case where a plurality of surveying operation must be executed to perform one type of surveying operation, it is necessary that an appropriate surveying instrument is selected for each surveying operation, a survey program for executing one surveying operation is executed, and after completion of this surveying operation, a next surveying operation is started. Therefore, the next surveying work cannot be started unless one type of surveying operation is completed, and for each surveying operation, a surveying instrument needs to be installed at the same location and leveled up, and therefore, the work efficiency is poor and the operation is troublesome.

In the present embodiment, a configuration is made in which, when the multifunctional apparatus 10 is installed at one point, survey programs related to a plurality of surveying operations can be executed. For example, even when performing a staking work using a hybrid survey system function and point cloud data observation (work) using a 3D scanner function, a point cloud data observation program can be executed by using the 3D scanner function after executing a staking program by using the hybrid survey system function. Accordingly, the work efficiency of the whole surveying work can be improved.

### 4. Modifications

### 4.1 Modification 1

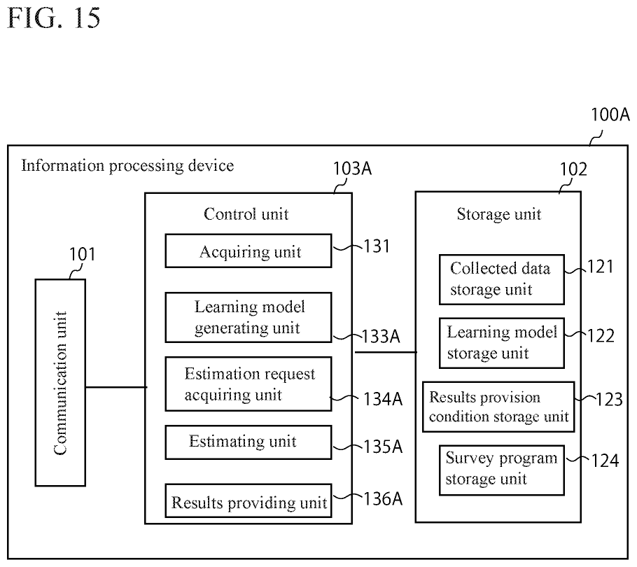

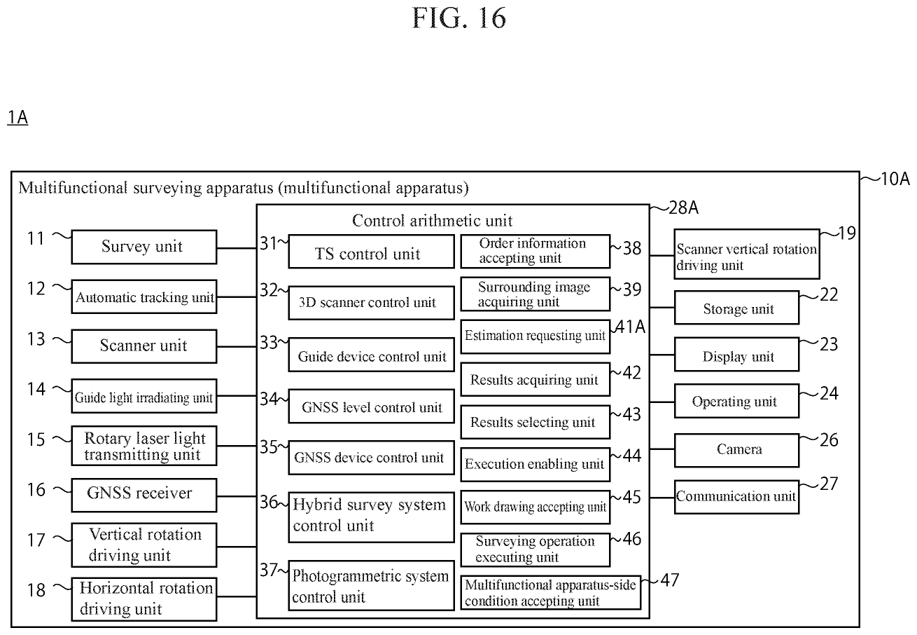

FIGS. 15 and 16 are respectively configuration block diagrams of an information processing device 100A and a multifunctional surveying apparatus 10A of a survey system 1A according to a modification of the present embodiment.

The multifunctional apparatus 10A has roughly the same configuration as the multifunctional apparatus 10, but additionally includes a multifunctional apparatus-side condition accepting unit 47, and includes an estimation requesting unit 41A in place of the estimation requesting unit 41.

The information processing device 100A has roughly the same configuration as the information processing device 100, but includes a learning model generating unit 133A in place of the learning model generating unit 133, an estimation request acquiring unit 134A in place of the estimation request acquiring unit 134, an estimating unit 135A in place of the estimating unit 135, and a results providing unit 136A in place of the results providing unit 136.

The multifunctional apparatus-side condition is a condition for, for example, accessories carried to the site, the number of workers sent to the site, and a work required time, and is a condition to exclude results not including these from estimation results. These may be used individually or in combination as the multifunctional apparatus-side condition.

In the present embodiment, operation-related information of collected data for learning model generation includes information corresponding to the multifunctional apparatus-side condition. For example, when the multifunctional apparatus-side condition concerns accessories, information on the accessories is included as operation-related information.

The multifunctional apparatus-side condition accepting unit 47 accepts a multifunctional apparatus-side condition input by a worker through the work unit 24.

When transmitting order information, a site surrounding image, and an estimation request to the information processing device 100A, the estimation requesting unit 41A transmits a multifunctional apparatus-side condition as well.

The learning model generating unit 133A generates a learning model by executing machine learning by using a teacher data set including the type of survey, attributes, and deliverables accuracy extracted from the order information and a site surrounding image as input data, and a combination of a surveying method, etc., and information on the multifunctional apparatus-side condition (for example, accessories) when the surveying work of the corresponding case was performed as output data.

The estimating unit 135A estimates a combination of a surveying method, etc., and information on the multifunctional apparatus-side condition from the order information on new surveying work accepted by the estimation request acquiring unit 134A based on the learning model stored in the learning model storage unit 122.

The results providing unit 136A provides estimation results to the multifunctional apparatus 10 by applying the multifunctional apparatus-side condition to the estimation results in addition to application of a condition stored in the results provision condition storage unit 123. Specifically, when the multifunctional apparatus-side condition concerns accessories, the results providing unit 136A excludes a surveying method, etc., requiring accessories other than the accessories accepted together with the estimation request from the estimation results and then provides the estimation results to the multifunctional apparatus 10A.

According to the configuration described above, for example, when the multifunctional apparatus-side condition concerns accessories, the learning model generating unit 133A can generate a learning model for estimating a combination of a surveying method, etc., and accessories. For a new case, by applying a multifunctional apparatus-side condition of excluding estimation results other than the accessories accepted by the multifunctional apparatus-side condition accepting unit 47, estimation results within a range using the accessories carried to the survey site can be provided. The multifunctional apparatus-side condition includes conditions for accessories carried to the site, the number of workers sent to the site, and a work time, etc., so that the survey system 1A can provide estimation results of a surveying method, etc., according to a work system at the site.

### 4.2 Another Modification

As another modification, it is also possible that, instead of including the survey program storage unit 124 in the information processing device 100, the storage unit 22 of the multifunctional apparatus 10 is configured to include the survey program storage unit 124, and in Step S208, the execution enabling unit 44 enables execution of a survey program stored in the survey program storage unit of the multifunctional apparatus 10 from the information processing device 100, and accordingly, execution of a selected surveying method using functions of a selected surveying instrument is enabled.

Although the preferred embodiment and modifications of the present invention have been described above, the above embodiment and modifications are examples of the present invention and these can be combined based on the knowledge of a person skilled in the art, and such combined embodiments are also included in the scope of the present invention.

### REFERENCE SIGNS LIST

1: Survey system (system)
1A Survey system (system)
10: Multifunctional surveying apparatus (multifunctional apparatus)
10A: Multifunctional surveying apparatus (multifunctional apparatus)
22: Storage unit
26: Camera
28: Control arithmetic unit
38: Order information accepting unit
39: Surrounding image acquiring unit
41: Estimation requesting unit
41A: Estimation requesting unit
42: Results acquiring unit
43: Results selecting unit
44: Execution enabling unit
45: Work drawing accepting unit
46: Surveying operation executing unit
47: Multifunctional apparatus-side condition accepting unit
100: Information processing device
100A: Information processing device
102: Storage unit
121: Collected data storage unit
122: Learning model storage unit
123: Results provision condition storage unit
131: Acquiring unit
133: Learning model generating unit
133A: Learning model generating unit
134: Estimation request acquiring unit
134A: Estimation request acquiring unit
135: Estimating unit
135A: Estimating unit
136 Results providing unit
136A Results providing unit
S: Surveying instrument

1. An information processing device comprising:
an acquiring unit configured to collect order information related to order details of surveying work, operation-related information related to a surveying operation for performing the surveying work, and a site surrounding image of the surveying work in relation to a plurality of kinds of surveying instruments;
a collected data storage unit configured to store the order information, the operation-related information, and the site surrounding image; and
a learning model generating unit configured to execute machine learning by using teacher data including the order information and the site surrounding image as input data, and the operation-related information as output data, and generate a learning model for estimating a surveying operation, a surveying instrument, and a surveying method for performing new surveying work according to order information and a site surrounding image related to the new surveying work, wherein
the operation-related information includes information on a surveying operation, a surveying instrument, and a surveying method for performing the surveying work, and
the learning model generating unit executes machine learning by extracting the type of survey of the surveying work, attributes of a surveying object, and required deliverables accuracy as characteristics from the order information and the site surrounding image.

2. The information processing device according to claim 1, further comprising:
an estimation request acquiring unit configured to accept order information and a site surrounding image related to the new surveying work together with a request to estimate a surveying operation, a surveying instrument, and a surveying method;
an estimating unit configured to estimate a surveying operation, a surveying instrument, and a surveying method for performing the new surveying work;
a results providing unit configured to provide results of the estimation;
a learning model storage unit configured to store the learning model; and
a results provision condition storage unit configured to store a provision condition of the estimation results, wherein
upon acquisition of the estimation request,
the estimating unit estimates a surveying operation, a surveying instrument, and a surveying method for executing the new surveying work from order information related to the new surveying work based on the learning model, and
the results providing unit provides results of the estimation by applying the provision condition.

3. A survey system comprising:
the information processing device according to claim 2; and
a multifunctional surveying apparatus having functions of a plurality of kinds of surveying instruments, and including a control arithmetic unit configured to control the functions of the plurality of kinds of surveying instruments, and a camera, wherein
the control arithmetic unit includes
an order information accepting unit configured to accept order information of new surveying work,
a surrounding image acquiring unit configured to acquire a site surrounding image by the camera,
an estimation requesting unit configured to transmit the order information and the site surrounding image to the information processing device together with a request to estimate a surveying operation, a surveying instrument, and a surveying method,
a results acquiring unit configured to acquire results of the estimation from the information processing device,
a results selecting unit configured to select a surveying method to be executed from the estimation results, and
an execution enabling unit configured to enable execution of a survey program for causing the multifunctional surveying apparatus to execute the selected surveying method.

4. The survey system according to claim 3, wherein
the multifunctional surveying apparatus further comprises a multifunctional apparatus-side condition accepting unit configured to accept a condition of a multifunctional apparatus-side surrounding the multifunctional surveying apparatus at the site when providing the estimation results,
the operation-related information further includes information corresponding to the multifunctional instrument-side condition,
the estimation requesting unit transmits the multifunctional apparatus-side condition to the information processing device together with the estimation request, and
the results providing unit provides the estimation results to the multifunctional surveying apparatus by applying the multifunctional apparatus-side condition to the estimation results.

5. The survey system according to claim 4, wherein the multifunctional apparatus-side condition includes at least one of the conditions for accessories carried to the site, the number of workers sent to the site, and a work required time.

6. A multifunctional surveying apparatus comprising:
a control arithmetic unit having functions of a plurality of kinds of surveying instruments and configured to control the functions of the plurality of kinds of surveying instruments; and
a camera, wherein
the control arithmetic unit includes
an order information accepting unit configured to accept order information of new surveying work,
a surrounding image acquiring unit configured to acquire a site surrounding image by the camera,
an estimation requesting unit configured to output the order information and the site surrounding image, and request estimation of a surveying work, a surveying instrument, and a surveying method,
a results acquiring unit configured to acquire estimation results based on a learning model,
a results selecting unit configured to select a surveying method to be executed from the estimation results, and
an execution enabling unit configured to enable execution of a survey program for causing the multifunctional surveying apparatus to execute the selected surveying method, and
the learning model is generated by executing machine learning of order information related to order details of surveying work, operation-related information related to a surveying operation for performing the surveying work, and a site surrounding image of the surveying work, collected in relation to the plurality of surveying instruments, by using teacher data including the order information and the site surrounding image as input data, and the operation-related information as output data.

7. The multifunctional surveying apparatus according to claim 6, further comprising:
a surveying operation executing unit configured to execute a survey program for causing the multifunctional surveying apparatus to execute a selected operation, wherein
the estimation results include results related to a plurality of surveying work, and
the surveying operation executing unit is configured so that, when the multifunctional surveying apparatus is installed at a predetermined point, in a case where there is a plurality of surveying work to be executed in relation to the point, the surveying operation executing unit can sequentially and individually execute the respective surveying work.
